(19) United States
(12) Patent Application Publication
(10) Pub. No.: US 2002/0193194 A1
(43) Pub. Date: Dec. 19, 2002

(54) Timing drive sprocket for direct injection engine

(76) Inventor: Isamu Okabe, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/167,315

(22) Filed: Jun. 10, 2002

(30) Foreign Application Priority Data
Jun. 18, 2001 (JP) 183959/2001

(51) Int. Cl. F16H 7/06; F16H 55/30; C23C 8/76; C23C 8/20

(52) U.S. Cl. 474/152; 474/156; 148/206

(57) ABSTRACT

A timing drive sprocket for a direct injection engine having excellent wear resistance, durability and quiet operation is produced by suppressing wear acceleration at the sprocket tooth surfaces resulting from deterioration of the engine oil, even in a direct injection engine of the kind in which the lubricating oil is likely to deteriorate rapidly. In the timing drive sprocket, a surface hardened layer is formed on at least a tooth surface of the sprocket by a carbonitriding and tempering treatment.

### FIELD OF THE INVENTION

This invention relates to a sprocket for use in the timing drive mechanism of a direct injection engine, such as a diesel engine or a direct injection gasoline engine, in which fuel is directly injected into air which has reached an elevated temperature as a result of high compression.

### BACKGROUND OF THE INVENTION

Chains, such as roller chains or silen chains, have been used in the timing drive mechanisms of engines used to power motor vehicles and the like. Sprockets made of a sintered alloy, carbon steel and alloy steel have been used with such chains, both as timing driving sprockets on crank shafts, and as driven sprockets on cam shafts.

In these timing drive sprockets a surface-hardening treatment such as a quenching-tempering treatment, or a carburizing-tempering treatment using high-frequency or the like, is carried out to improve the strength of tooth surfaces and wear resistance of the sprocket as taught in Japanese Laid-open Patent Publication No. 239710/2000. The surface-hardened timing drive sprockets have been used widely in the timing drive mechanisms of gasoline engines.

In a direct injection gasoline engine or a diesel engine, fuel is directly injected into a cylinder. In both kinds of direct injection engines, two phenomena occur which contribute to the deterioration of the engine lubricating oil. One such phenomenon is the so-called “half-burning” phenomenon, in which flame propagation is stopped during burning. Another phenomenon observed in the operation of direct injection engines is that the diffusion of fuel may not proceed during mixing thereof. Both these phenomena result in the generation of carbon soot in large amounts. Carbon soot, which is cinder, becomes mixed with the engine lubricating oil. Thus, in a direct injection gasoline engine or a diesel engine, deterioration of engine oil is more significant than the engine oil deterioration that occurs in a conventional gasoline engine, where combustion is more nearly perfect.

When a conventional timing drive sprocket is used in a direct injection engine, the wear of the sprocket is significantly greater when it is exposed to oil that has deteriorated, than when it is lubricated by new oil.

The carbon soot generated in a direct injection engine contains many functional groups, such as a carboxylic group (COOH), derived from the organic compounds, which are the principal components of gasoline, diesel fuel, and the like. When a sprocket subjected to conventional carburizing treatment is used in the timing drive mechanism of a direct injection engine, carbon in iron carbide is decomposed and separated away by the above-mentioned functional groups in a very thin surface layer (about a few nanometers thick) of the timing drive sprocket. The metallic structure of the iron carbide is broken down in the thin, outermost surface layer of the sprocket and the surface layer is softened so that the surface of the sprocket is worn further by sliding contact with the timing drive chain.

In FIG. 3, curve (c) shows the results of measurement of the amount of wear of tooth surfaces of sprockets when non-deteriorated new oil was used as a lubricant for a conventional diesel engine timing drive sprocket in the production of which, after chromium-molybdenum steel (SCM420) was subjected to grinding and tooth cutting, it was subjected to carburizing and tempering. In the same figure, curve (b) shows the progression of wear of the sprocket tooth surfaces when deteriorated oil mixed with carbon-soot was used as lubricant.

The test conditions for measurement of the amount of wear in the tooth surface of the sprocket were as follows.

a) Timing drive chain: a silent chain having a pitch of 6.35 mm;

b) Number of teeth of the sprocket: 21;

c) Load on the chain: 1.5 kN;

d) Rotational speed: 6500 rpm.

As apparent from the results shown in FIG. 3, the timing drive sprocket subjected to conventional carburizing and tempering treatment exhibited a very large amount of wear when deteriorated oil mixed with carbon soot was used as a lubricant, as compared with the amount of wear occurring when new oil was used as a lubricant. The wear resulting from deteriorated oil containing carbon soot ultimately results in meshing failures such as tooth skip.

In the timing driving sprocket subjected to conventional carburizing and tempering treatment, when the amount of wear in the tooth surface of the sprocket increases, meshing noises between the chain and the sprocket increase, which is disadvantageous.

FIG. 4 shows the results of measurements obtained by comparing meshing noises between two timing drive mechanisms. Plot (b1) shows the noise produced by a timing drive sprocket in which 0.2 mm of wear was generated on the tooth surfaces of the sprocket, and curve (b2) shows the noise produced by a new timing driving sprocket. As apparent from these measured results, the worn timing driving sprocket produces a noise level about 2 to 3 dB higher, on the average, than the noise level produced by the new timing drive sprocket, over a wide range of rotational speeds.

The test conditions for testing meshing noises were as follows.

a) Timing driving chain: a silent chain of a pitch of 6.35 mm;

b) Number of teeth of the driving side sprocket: 21;

Number of teeth of the driven side sprocket: 42;

c) Load on the chain: 0.7 kN;

d) Rotational speed of the driving side sprocket: 500-5000 rpm.

The powder produced when a timing drive sprocket is worn, is mixed with the lubricating oil and acts as a polishing material. Thus, it generates wear not only in the sprocket or chain but also in other engine components such as a tensioner lever or a chain guide, which are associated with the timing drive. As the wear of the timing drive sprocket proceeds, several problems arise. One such problem is tooth skip of the timing driving chain caused by meshing abnormalities in the chain, In a worst case, a tooth of the sprocket may be broken, which can lead to damage to the engine.

### SUMMARY OF THE INVENTION

Accordingly, a general object of the invention is to solve the above-mentioned problems in a timing drive sprocket used for a timing drive mechanism in a conventional direct injection engine.

Another object of the invention is to provide a timing drive sprocket for a direct injection engine, which suppresses the acceleration of wear in the tooth surfaces of the sprocket resulting from the deterioration of the engine lubricating oil, even in a direct injection engine in which the engine oil is likely to deteriorate rapidly, and which has improved wear resistance, durability and quiet operation.

According to one aspect of the invention, in a timing drive sprocket for a direct injection engine, a surface-hardened layer is formed on at least a chain-contacting tooth surface of the sprocket by carbonitriding and tempering treatments. “Carbonitriding,” which may also be referred to as “carburizing-nitriding,” is a surface treatment in which carburizing and nitriding are carried out simultaneously. The timing drive in accordance with the invention is especially advantageous in a diesel engine or a direct injection gasoline engine.

The basic production process is similar to the conventional process for producing timing drive sprockets, except that, in quenching and tempering, a carbonitriding treatment is performed.

Any of several conventional sprocket production processes may be used.

According to one conventional process, a raw material consisting of regular cast iron (FC25-30), carbon steel, alloy steel or the like is worked by casting, steel material cutting, or forging. Thereafter grinding and tooth cutting are carried out, followed by high frequency quenching and tempering.

In another conventional process, the raw material consists of iron powder, graphite powder and the like mixed with each other and molded. The molded mixture is then subjected to a sintering process, followed by high frequency quenching and tempering.

In still another conventional process, the raw material is a rolled steel sheet suitable for deep drawing. The steel sheet is punched, subjected to a drawing process and a bonding treatment, tooth forming, and then high frequency quenching and tempering.

For the timing drive chain which meshes with the sprocket, either a roller chain and a silent chain may be used.

According to the invention, a surface-hardened layer is formed on at least a chain-engaging surface of the sprocket teeth by carbonitriding and tempering. The hardened state of the sprocket teeth produced by this treatment suppresses the wear of the tooth surfaces, even when lubricated by lubricating oil with which a significant quantity of carbon soot is mixed. Consequently the timing drive sprocket can rotate quietly and smoothly for a long period of time.

The manner in which the carbonitriding and tempering treatment enables even carbon-soot containing lubricating oil to suppress wear of timing drive sprocket is not known with certainty. However, it can be surmised that the nitrogen contained in the composition of the hardened tooth surfaces suppresses the decomposition and separation of carbon in the carbide of the surface layer, and further suppresses the softening of the outermost surface layer and the acceleration of wear in the outermost layer.

### BRIEF DESCRIPTION OF THE DRAWINGS

Preferred embodiments of the invention will now be described in detail, by way of example only, with reference to the accompanying drawings, in which:

FIG. 1 is a schematic view of a timing drive sprocket for a direct injection engine according one embodiment of the invention;

FIG. 2 is a graph comparing carburized, nitrided sprockets of the invention with carburized conventional sprockets;

FIG. 3 is a graph showing the wear of tooth surfaces of a conventional sprocket and a sprocket in accordance with the invention, as engine lubricating oil deteriorates over time; and

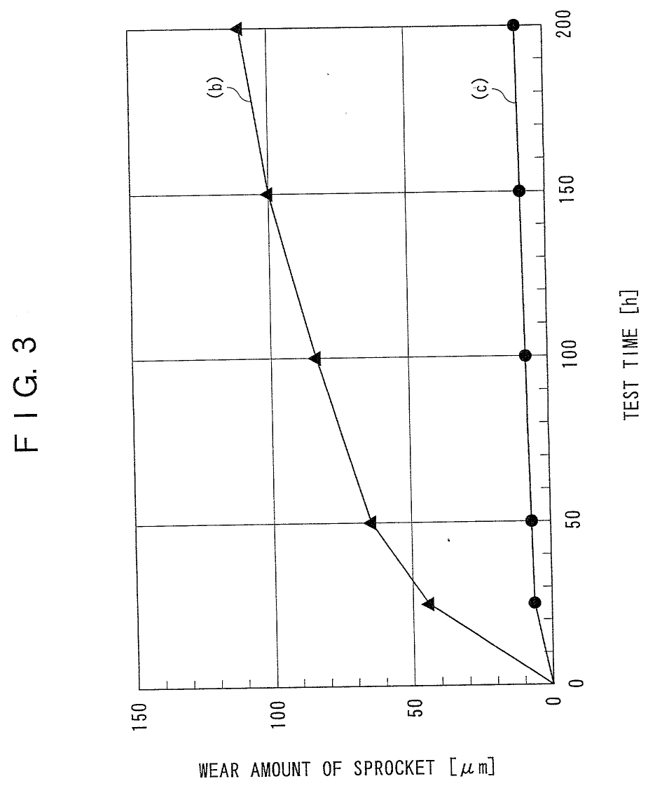

FIG. 4 is a graph comparing the noise produced by a conventional timing drive and a timing drive in accordance with the invention at various rotational speeds.

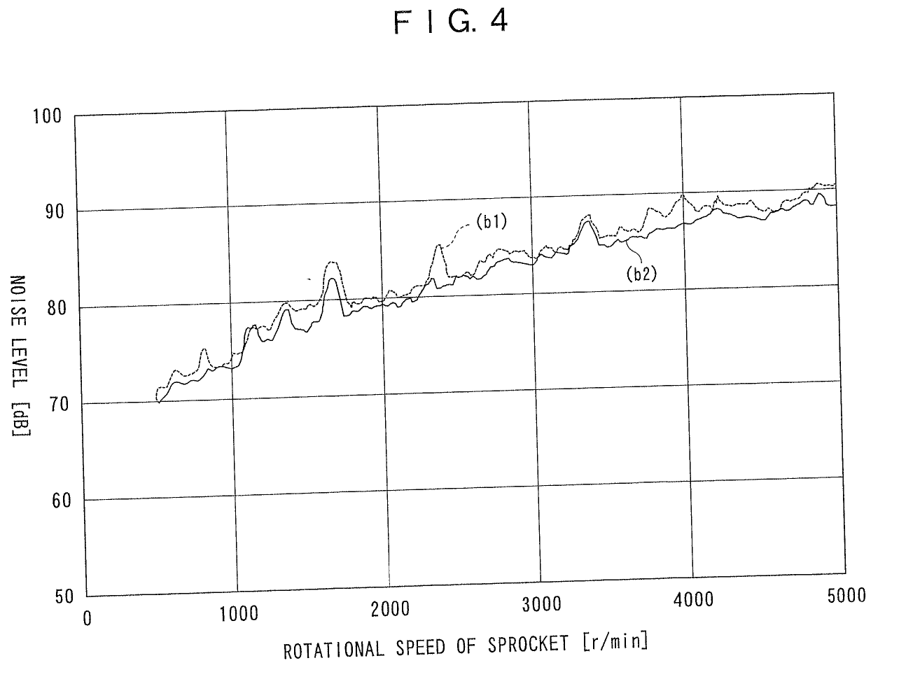

### DETAILED DESCRIPTION OF THE PREFERRED EMBODIMENT

Preferred embodiments of a timing drive sprocket according to the invention will be described below with reference to drawings.

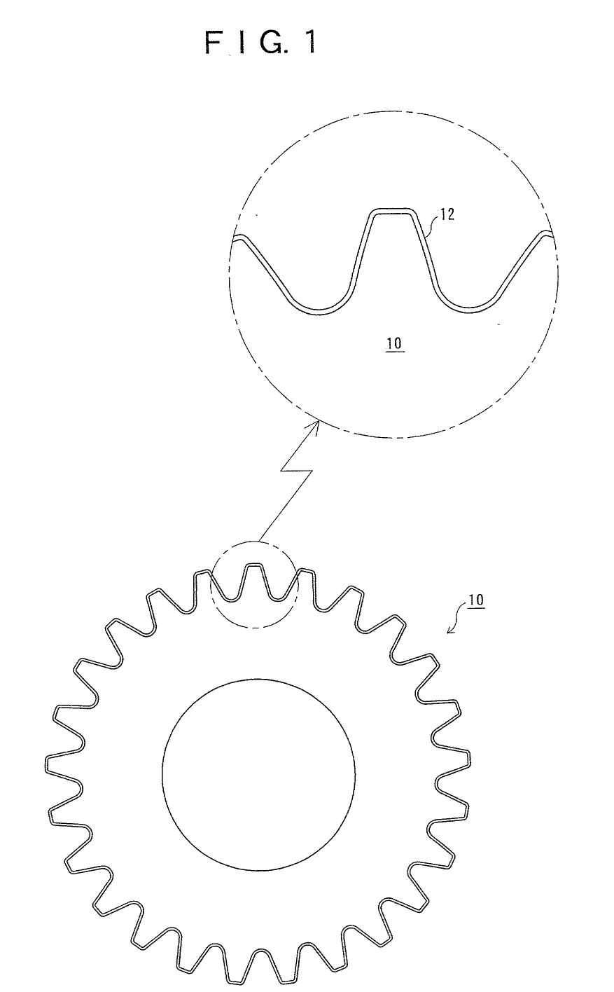

A sprocket 10 to be used in the timing drive mechanism for a diesel engine was produced by grinding of chromium molybdenum steel (SCM 420), tooth cutting, and subsequently carbonitriding and tempering. A surface-hardened layer 12 was formed on sprocket tooth surfaces as shown in FIG. 1.

To check the effects of the sprocket thus obtained, two sprockets were produced. The first was produced in accordance with the invention by subjecting chromium molybdenum steel (SCM 420) to grinding and tooth cutting, and thereafter, carbonitriding and tempering. The second was a conventional sprocket produced by subjecting chromium molybdenum steel (SCM 420) to grinding and tooth cutting, and thereafter, carburizing and tempering. The wear of these sprockets was measured by operating them in deteriorated oil containing carbon soot under the following test conditions.

a) Timing drive chain: a silent chain having a pitch of 6.35 mm;

b) Number of teeth of the sprocket: 21;

c) Load on the chain: 1.5 kN;

d) Rotational speed: 6500 rpm.

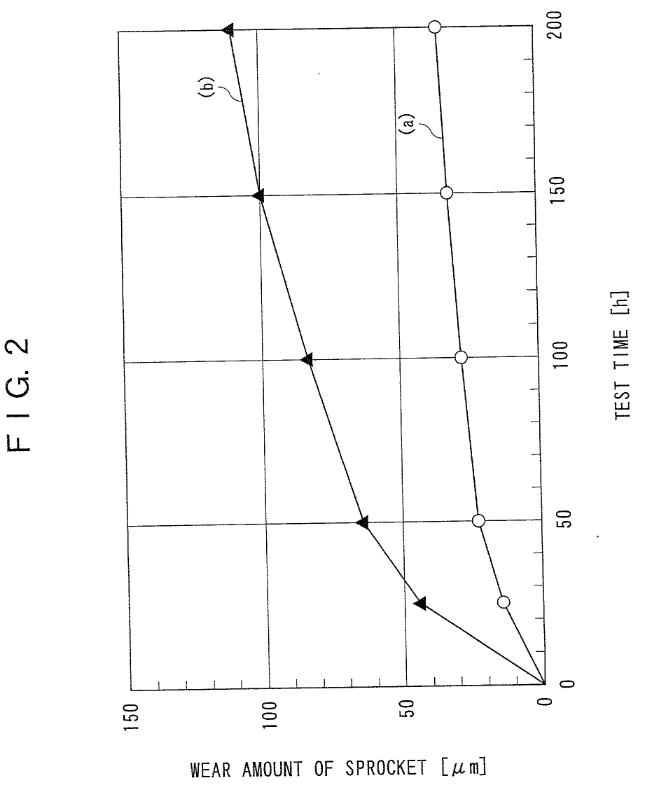

FIG. 2 shows the wear in the sprockets over 200 hours of operation. As apparent from the results shown in FIG. 2, the wear of the sprocket subjected to the carbonitriding and tempering was one-third or less compared to the wear of the conventional sprocket subjected to carburizing and tempering. The same effect was also obtained after 200 hours. The results of the measurements show that the carbonitriding and tempering treatment has a significant effect as a surface-hardening treatment for a sprocket to be used in a direct injection engine.

Although the sprockets used in the above example were produced from chromium molybdenum steel (SCM 420), the same effects can be observed in the cases of sprockets made from other steel alloys such as SCr and sintered alloys.

As explained above, the timing drive sprocket according to the invention exhibits excellent wear resistance, durability and quiet operation, by suppressing wear acceleration at the sprocket tooth surfaces resulting from deterioration of the engine lubricating oil, even in a direct injection engine of the kind in which the engine oil is likely to deteriorate rapidly. These results are achieved by forming a surface-hardened layer by carbonitriding and tempering treatment on at least the tooth surfaces of the sprocket which come into contact with the timing chain in the timing drive mechanism of a diesel engine or a direct injection gasoline engine.

In the timing drive sprocket according to the invention, a carbonitriding and tempering treatment was adopted as a surface hardening method for the sprocket. In accordance with the invention, a lower carburizing temperature can be used than in the case of a conventional carburizing and tempering treatment for a timing sprocket. Accordingly, the surface-hardening treatment of the invention can be performed easily and the production cost of the sprocket is not significantly increased.

Various minor changes and modifications of the invention are possible in the light of the above teaching. It is therefore to be understood that within the scope of the appended claims, the invention may be practiced otherwise than as specifically described.

What is claimed is:

1. A timing drive sprocket for a direct injection engine, wherein a surface-hardened layer is formed on at least a chain-contacting tooth surface of the sprocket by carbonitriding and tempering treatments.

2. In combination with a direct injection engine, a timing drive sprocket, wherein a surface-hardened layer is formed on at least a chain-contacting tooth surface of the sprocket by carbonitriding and tempering treatments.

3. The combination according to claim 2, in which the direct injection engine is a diesel engine or a direct injection gasoline engine.

4. A method of producing a timing drive for a direct injection engine, comprising forming a surface-hardened layer on at least a chain-contacting surface of a sprocket of the timing drive by carbonitriding and tempering treatments.

5. A method according to claim 4, in which the sprocket having a surface-hardened layer is installed in a direct injection engine as part of a timing drive therein.

6. A method according to claim 4, in which the sprocket having a surface-hardened layer is installed in a diesel engine or a direct injection gasoline engine as part of a timing drive therein.
